(19) United States
(12) Patent Application Publication
(10) Pub. No.: US 2004/0003257 A1
(43) Pub. Date: Jan. 1, 2004

(54) Network accessible and controllable security system for a multiple of electronic door locks within a multi-room facility

(76) Inventor: Ernst Kern Mitchell, Sterling Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/183,062

(22) Filed: Jun. 26, 2002

(51) Int. Cl. H04L 9/00

(52) U.S. Cl. 713/182

(57) ABSTRACT

A security system includes a central controller which communicates with a multiple of electronic door locks within a multi-room facility. The central controller communicates with each electronic lock through a room transceiver located proximate the electronic lock. A display communicates with the room transceiver to provide messages and other services to each room. In operation, the system provides a multiple of security and key tracking services. Each electronic lock receives instruction from the central controller such as access for a particular key or cancellation of keys through the in-room transceiver. Historical key tracking allows tracking and efficiency management of staff. A single staff person can also be located by searching for the predetermined code for the desired staff person. Maintenance of each electronic lock is also simplified.

### BACKGROUND OF THE INVENTION

The present invention relates to a security system, and more particularly to electronic door locks which communicate with a central controller to remotely manage access thereto.

Multi-room facilities such as hotels, condominiums, student housing, assisted living, and other properties commonly utilize electronic door locks. Keys are programmed to allow particular individuals access to particular rooms.

Difficulties may arise when one resident of a room replaces another as the new resident must be provided with a key distinct from the previous resident such that the previous resident no longer has access to the room. Typically, the electronic lock operates by recognizing the more recently created key such that any previous key no longer unlocks the electronic lock. In some cases when duplicate keys are programmed to access the same room, the other previously programmed key is disabled. Such an occurrence may result when a husband is provided with a key for a room and a wife is later provided with a second key for the same room. Care must be taken to assure that both keys unlock the electronic lock.

Often it is desirable to immediately cancel access to a properly programmed key for a particular electronic lock. A properly programmed key is typically programmed to access a room for a predetermined time period or until a newly programmed key is inserted into the lock. To cancel access to the room for the properly programmed key prior to expiration of the key, a staff person is required to physically insert a key into the electronic lock. This may be time consuming for large multi-room facilities.

Other difficulties may arise when staff are provided with keys which allow access to multiple rooms for cleaning or other tasks. The staff person is in possession of a key which accesses multiple rooms and it is difficult to track usage of the multi-room key.

Maintenance such as battery replacement, time correction, and data upgrades for the electronic lock are regularly required. Typically, a particular light combination alerts a staff member to replace the battery. Disadvantageously, staff must have direct access to the electronic lock to identify the light combination. This is time consuming for a large multi-room facility and may result in a guest not having access to a room because the battery failed. Such difficulties are also encountered when software upgrades for the electronic lock are required as a staff member must physically visit each and every electronic lock to install the software upgrade.

Accordingly, it is desirable to provide a security system for a multi-room facility which provides key control, identifies historical usage, and allows maintenance from a remote location.

### SUMMARY OF THE INVENTION

The security system according to the present invention includes a central controller and an electronic door lock for each room within a multi-room facility. Each electronic lock includes a microprocessor, a memory which communicates with the microprocessor and a transceiver. The microprocessor communicates with a key slot which reads a programmable key having a key storage device such as a magnetic strip. The key storage device retains information such as a unique predetermined code which is identifiable by the microprocessor.

The central controller communicates with each electronic lock through a room transceiver located proximate the electronic lock.

A display communicates with the room transceiver to provide messages and other services to each room. The display includes a television as hotel rooms and the like are commonly already so equipped.

A multi-entry key is identifiable by the microprocessor within the electronic lock to unlock the door in a conventional manner. Once the key is identified, the microprocessor instructs the lock transceiver to transmit the predetermined code stored on the key to the room transceiver. From the room transceiver the predetermined code is communicated to the central controller. The time that the key is inserted into the lock is also transmitted to the central controller. The predetermined key code and the entry time is then stored in a database for later retrieval.

In operation, the present invention provides a multiple of security and key tracking services. The present invention provides for remote interrogation of each electronic lock. That is, each electronic lock receives instruction from the central controller such as access for a particular key or cancellation of keys through the in-room transceiver. The present invention also provides historical and tracking benefits which allows tracking and efficiency management of staff. A single staff person can also be located by searching for the predetermined code for the desired staff person.

Maintenance of each electronic lock is also simplified as when an electronic lock identifies it has encountered a failure or potential for failure through an on-board self-test routine, the electronic lock sends a message to the central controller. Another maintenance function that is also simplified by the present invention is software upgrades for the electronic locks. The central controller sends the updated instruction set to each electronic lock through the transceiver which then communicates the new instruction set to the electronic lock memory. A large number of electronic locks are thereby updated essentially instantaneously.

The present invention therefore provides a security system for a multi-room facility which provides key control, identifies historical usage, and allows electronic lock maintenance from a remote location.

### BRIEF DESCRIPTION OF THE DRAWING

The various features and advantages of this invention will become apparent to those skilled in the art from the following detailed description of the currently preferred embodiment. The drawing that accompanies the detailed description can be briefly described as:

FIG. 1 is a general schematic view of a security system for a multi-room facility designed according to the present invention.

### DETAILED DESCRIPTION OF THE PREFERRED EMBODIMENT

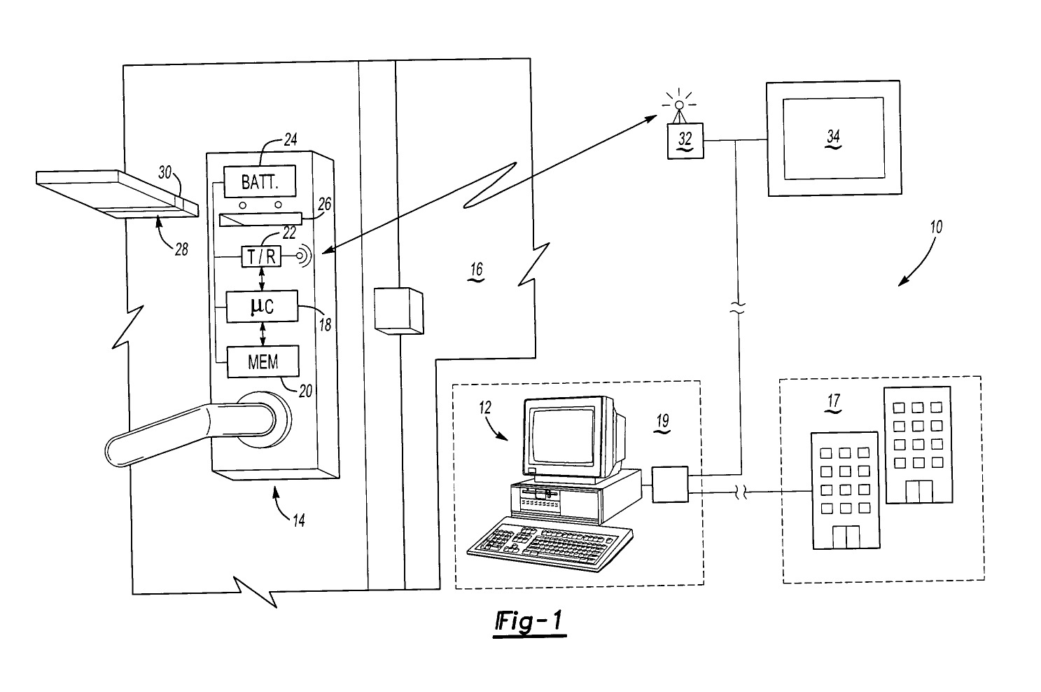

FIG. 1 illustrates a general schematic view of a security system 10 for a multi-room facility such as hotels, condominiums, student housing, assisted living, and other properties which commonly utilize electronic door locks. It should be understood that other a multi-room facilities which serve numerous residents will benefit from the present invention.

The security system 10 generally includes a central controller 12 and an electronic door lock 14 of a room 16. It should be understood that although only a single room 16 is illustrated, the central controller communicates with a plurality of rooms in the multi-resident facility. Moreover, the central controller may alternatively or additionally communicate with a multiple of multi-resident facilities (indicated schematically at 17) such that a single central controller 12 communicates with, for example only, a multiple of hotels. The central controller is preferably a person computer or the like which is located in a remote area 19 of the multi-room facility separate from room 16.

Each electronic lock 14 preferably includes a microprocessor (illustrated schematically at 18) a memory (illustrated schematically at 20) which communicates with the microprocessor 18 and a transceiver 22. The memory 20 may include non-volatile memory, hard drive, CD ROM, DVD, RAM, ROM or other optically readable storage, magnetic storage or integrated circuit. A battery (illustrated schematically at 24) within the electronic lock 14 provides power for lock activation in response to the microprocessor 18. The microprocessor 18 communicates with a key slot 26 which reads a programmable key 28. The key 28 typically contains a storage device 30 such as a magnetic strip or integrated circuit which retains information such as a unique predetermined code which is identifiable by the microprocessor 18. Various types of keys will benefit from the present invention.

The central controller 12 communicates with a wireless room transceiver 32 located proximate the electronic lock 14. Although the transceiver 32 is located within the room proximate the electronic lock 14 in the illustrated embodiment, it should be understood that the transceiver 32 will preferably communicate with a multiple of electronic locks for a multiple of rooms. It should also be understood that although the central controller 12 is illustrated as hard wired to the room transceiver 32, the central controller 12 may alternatively or in addition communicate with each transceivers in a wireless manner. The room transceiver 32 communicates with the transceiver 22 within the electronic lock 14 through two-way radio frequency (RF) signals. Although the communication components are identified herein as transceivers it should be understood that other wireless communication devices will also benefit from the present invention. Preferably, each room that is accessible with the electronic lock 14 includes a transceiver 32.

A display 34 communicates with the transceivers 32 to provide messages and other services to each room. The display 34 is preferably a television as hotel rooms and the like are commonly already so equipped.

In operation, the present invention provides a multiple of services and benefits. Because each electronic lock 14 is in communication with the central controller 12, through transceivers 22,32 functions which heretofore required a staff person to physically visit a particular electronic lock are avoided.

The present invention provides for remote interrogation of each electronic lock. That is, each electronic lock receives instruction from the central controller 12 through the in-room transceiver 32. For example, should a particular electronic lock refuse access to an authorized key, the electronic lock 14 may be reset remotely from the central controller. Conversely, a particular electronic lock 14 may be remotely instructed to immediately ignore a previously properly authorized key. That is, the key which would previously allow access is remotely cancelable from the central controller without the need for a staff member to physically visit that particular electronic lock. For example, as soon a guest checks out such as through the in room display 34, the key which would previously allow access is immediately cancelled upon check out.

The present invention provides historical and tracking benefits. Staff, such as cleaning personnel, are commonly supplied with a multi-entry key which provides access to multiple electronic locks. Each key includes a predetermined code stored upon the key storage device 30. The predetermined code according to the present invention is unique to a particular user. Even a relatively common magnetic strip storage device provides ample storage for the common function of unlocking a plurality of electronic locks, the unique predetermined code according to the present invention, and other data.

The multi-entry key is identifiable by the microprocessor 18 within the electronic lock 14 to unlock the door in a conventional manner. Once the key is identified, the microprocessor 18 instructs the lock transceiver 22 to transmit the predetermined code from the key to the room transceiver 32. From the room transceiver 32 the predetermined code is communicated to the central controller 12. Preferably, the time that the key is inserted into the lock is also transmitted to the central controller 12. The predetermined key code and the entry time is then stored in a database or the like for later retrieval. This historical tracking preferably occurs each time a key is inserted into an electronic lock.

The central controller 12 thereby provides for tracking of particular staff members that are assigned a multi-entry key having a unique predetermined code. For example, the cleaning efficiency of each staff member can be tracked by comparing the difference in time between that staff persons access to a multiple of rooms in a sequence. Moreover, comparisons can be made which determine whether multiple staff persons have accessed the same room at the same time.

A single staff person can also be located by searching for the predetermined code for the desired staff person. As the central controller 12 is updated in real time each time a key is inserted into an electronic lock 14, the progress and current location of each staff person is immediately available at the central controller 12.

Maintenance of each electronic lock 14 is also simplified by the present invention. When an electronic lock identifies it has encountered a failure or potential for failure through an on-board self-test routine, the electronic lock sends a message to the central controller 12. The on-board self-test routine are preferably stored in memory 20. Self-testing code is well known. One such self-test is determination of a low power condition which necessitates battery replacement. A staff member can then be directed to the particular electronic lock immediately upon such notification. The likelihood of a guest encountering difficulty with an electronic lock having a low battery condition is thereby minimized.

Another maintenance function that is also simplified by the present invention is software upgrades for the electronic locks 14. Heretofore, a staff member must physically visit each electronic lock and upgrade the software through an input into the key slot. The central controller 12 of the present invention sends the updated instruction set to each electronic lock through the room transceiver 32 which then communicates the new instruction set to the electronic lock memory 20 through the lock transceiver 22. A large number of electronic locks are thereby updated essentially instantaneously.

Another maintenance function that is also simplified by the present invention is updating the clock in the electronic locks 14. Heretofore, a staff member must physically visit each electronic lock and set the clock to correct to the current time. The central controller 12 of the present invention sends the updated time to each electronic lock through the room transceiver 32 to the electronic lock memory 20 through the lock transceiver 22. A large number of electronic lock clocks are thereby updated essentially instantaneously and may be updated regularly to coincide with the central processor 12.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A security system for a multi-room facility comprising:
a central controller;
an electronic door lock which is unlocked by a first key which unlocks only said electronic door lock and a second key which unlocks a plurality of other electronic door locks;
a lock transceiver in communication with said electronic door lock; and
a room transceiver located proximate said electronic door lock, said room transceiver in communication with said central controller and said lock transceiver to provide communication between said central controller and said electronic door lock, said central controller operable to identify each unlock event of said first electronic door lock.

2. The system as recited in claim 1, further comprising a display in communication with said transceivers to display information from said central controller.

3. The system as recited in claim 2, wherein said display comprises a television.

4. The system as recited in claim 1, wherein said central controller tracks a time representative of each unlock event.

5. The system as recited in claim 1, wherein said central controller tracks a code unique to said second key when said second key is inserted into said electronic door lock, said code communicated from said lock transceiver, to said room transceiver and from said room transceiver to said central controller.

6. The system as recited in claim 1, wherein said central controller communicates with a plurality of said electronic door locks to identify a history for said second key.

7. The system as recited in claim 1, wherein said central controller communicates with said electronic door lock to identify a status of said electronic door lock.

8. The system as recited in claim 7, wherein said status of said electronic door lock comprises a battery condition of a battery within said electronic door lock.

9. The system as recited in claim 1, wherein said central controller communicates with said electronic door lock to cancel said first key which previously unlocked said electronic door lock.

10. The system as recited in claim 1, wherein said room transceiver remotely communicates with said lock transceiver via two-way radio frequency.

11. The system as recited in claim 1, wherein said central controller communicates with said room transceivers over a local area network.

12. The system as recited in claim 1, wherein said central controller communicates with a plurality of locations over a wide area network, each of said plurality of locations comprising a plurality of said electronic door locks.

13. A method of communicating with a plurality of electronic door locks from a central controller comprising the steps of:
(a) communicating between a central controller and a plurality of room transceivers, each of the plurality of transceivers proximate an associated electronic door lock;
(b) communicating between each of the plurality of room transceivers and the associated electronic door lock; and
(c) tracking each unlock event for each of the plurality of electronic door locks.

14. A method as recited in claim 13, wherein step (c) comprises the step of:
tracking a time of each unlock event for each of the electronic door locks.

15. A method as recited in claim 13, further comprising the step of:
tracking a code unique to a key when the key unlocks any of the electronic door locks.

16. A method as recited in claim 13, further comprising the step of:
communicating with a plurality of the electronic door locks to identify a history for a predetermined key.

17. A method as recited in claim 13 further comprising the steps of:
recording a time a predetermined key unlocks a first electronic door lock; and
recording a time the predetermined key unlocks a second electronic door lock.

18. A method as recited in claim 13 further comprising the steps of:
recording a time the predetermined key unlocks a first electronic door lock; and
recording a time the predetermined key unlocks a second electronic door lock.

19. A method as recited in claim 13 further comprising the steps of:
identifying a status of each of the electronic door locks.

20. The system as recited in claim 13, further comprising the steps of:
identifying a battery condition of each of the electronic door locks.

21. The system as recited in claim 13, further comprising the steps of:
communicating with a first electronic door lock; and
canceling a key which previously unlocked the first electronic door lock.

22. The system as recited in claim 13, wherein said step (b) further comprising the steps of:
communicating between each of the plurality of room transceivers and an associated display.
